(19) United States
(12) Patent Application Publication
(10) Pub. No.: US 2015/0251297 A1
(43) Pub. Date: Sep. 10, 2015

(54) ADJUSTABLE SOCKET

(71) Applicant: YA-SHUN CHANG, Taichung City (TW)

(72) Inventor: YA-SHUN CHANG, Taichung City (TW)

(21) Appl. No.: 14/229,966

(22) Filed: Mar. 30, 2014

(30) Foreign Application Priority Data
Mar. 7, 2014 (TW) 103107818

(51) Int. Cl. B25B 13/18; B25B 23/00

(52) U.S. Cl. CPC B25B 13/18; B25B 23/0007

(57) ABSTRACT

An adjustable socket is provided. A main tubular body has a circumferential elongated through slot, an urging hole and a central axis. The inner wall of the urging hole forms a cam surface. A drive member has a drive portion and is positionably assembled within an end of the main tubular body. A guiding member is assembled within the main tubular body and has a guiding slot formed radially. Each of two jaw members includes a guiding portion slidably disposed in the guiding slot and a jaw connected with the guiding portion. The two jaws extend into the urging hole. The first elastic member abuts between the two guiding portions. A sleeve ring is rotatably disposed around the main tubular body. A pin is disposed through the elongated through slot and positionably connected respectively to the sleeve ring and the guiding member.

### BACKGROUND OF THE INVENTION

1. Field of the Invention

The present invention relates to a socket, and more particularly to an adjustable socket.

2. Description of the Prior Art

It is quite common to use bolts and nuts to fix and assemble machines, installations or devices. Either of assembling or disassembling needs an appropriate tool, and a hand tool is economical, convenient and easy to get.

It is ordinary to use a wrench and a socket assembled with the ratcheting portion of the wrench as the hand tool in prior techniques. The socket includes a socket head protruding downwardly, and the socket head is able to be connected with the sockets in different kind of dimensions for tightening or releasing the bolts and the nuts in different dimensions. The sockets are disassembled and replaced to match the socket head of the wrench, so that the wrench is able to collocate with a variety of sockets for tightening or releasing the bolts and the nuts in different dimensions.

However, the bolts and the nuts needed to be tightened or released are numerous in dimensions in a work, so that a socket set composed with a variety of sockets is usually required, and one socket is only suitable for one bolt or one nut with the corresponding dimension to the socket. So that it is inconvenient to the work and takes a lot of time. More seriously, a work is unable to be done without a socket with a corresponding dimension in need.

An adjustable socket is disclosed in U.S. Pat. No. 7,261,021, and it is formed with an outer shell disposed on an inner drive member. By rotating the outer shell relatively to the inner drive member, and forcing two jaws movably disposed in the inner drive member through an urging hole on the outer shell to move relatively close to or far away from each other. And by using an inner tooth and an outer tooth which are disposed on the outer shell and the inner drive member and engaged with each other, the adjustable socket is able to be adjusted in the dimension.

However, this kind of adjustable socket needs the inner tooth and the outer tooth on the outer shell and the inner drive member. The structure of the inner tooth and the outer tooth is complicated, so that the processing of the structure is difficult and the cost is high. So that it is unfavorable for manufacturing and mass production. Besides, when adjusting the adjustable socket, the outer shell and the inner drive member need to be moved axially to make the inner tooth and the outer tooth separate. And after the adjustable socket is adjusted to a specific dimension, the outer shell and the inner drive member need to be moved axially again to make the inner tooth and the outer tooth engage to each other for using. There are too many operating procedures and it is inconvenient. This disadvantage is needed to be improved.

The present invention has arisen to mitigate and/or obviate the afore-described disadvantages.

### SUMMARY OF THE INVENTION

The primary object of the present invention is to provide an adjustable socket. By a single procedure, the adjustable socket is able to be adjusted to a specific dimension quickly and applied to bolts and nuts with a variety of dimensions. It is easy, fast and convenient to use. The structure is simple, and the processing is easy and the cost is low. So that it is favorable for manufacturing and mass production.

To achieve the above object, an adjustable socket in accordance with present invention includes a main tubular body, a drive member, a guiding member, two jaw members, a first elastic member, a sleeve ring and a pin. The main tubular body has an elongated through slot circumferentially formed thereon and an urging hole at one end thereof. The main tubular body has a central axis, and relative to the central axis the inner wall of the urging hole forms a cam surface. The drive member has a drive portion and is positionably assembled within the other end of the main tubular body. The guiding member is assembled within the main tubular body, and relative to the main tubular body the guiding member has a guiding slot formed radially. Each jaw member includes a guiding portion slidably disposed in the guiding slot and a jaw connected with the guiding portion. The two jaws extend into the urging hole and are opposite to each other. The first elastic member elastically abuts between the two guiding portions. The sleeve ring is rotatably disposed around the main tubular body. The pin is disposed through the elongated through slot and two ends thereof are positionably connected respectively to the sleeve ring and the guiding member. When the sleeve ring and the main tubular body rotate relative to each other, the two jaws move along the cam surface and radially move oppositely relative to the central axis.

### BRIEF DESCRIPTION OF THE DRAWINGS

FIG. 1 is a breakdown drawing showing a preferable embodiment of the present invention;

FIG. 2 is a three-dimensional drawing showing a preferable embodiment of the present invention;

FIG. 3 is a first axial cross-sectional drawing showing a preferable embodiment of the present invention;

FIG. 4 is a second axial cross-sectional drawing showing a preferable embodiment of the present invention;

FIG. 5A is a first radial cross-sectional drawing showing a preferable embodiment of the present invention;

FIG. 5B is a second radial cross-sectional drawing showing a preferable embodiment of the present invention;

FIG. 5C is a third radial cross-sectional drawing showing a preferable embodiment of the present invention;

FIG. 6-7 are perspective drawings showing a preferable embodiment of the present invention in adjusting;

FIG. 8 is a perspective drawing showing a preferable embodiment of the present invention in use.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

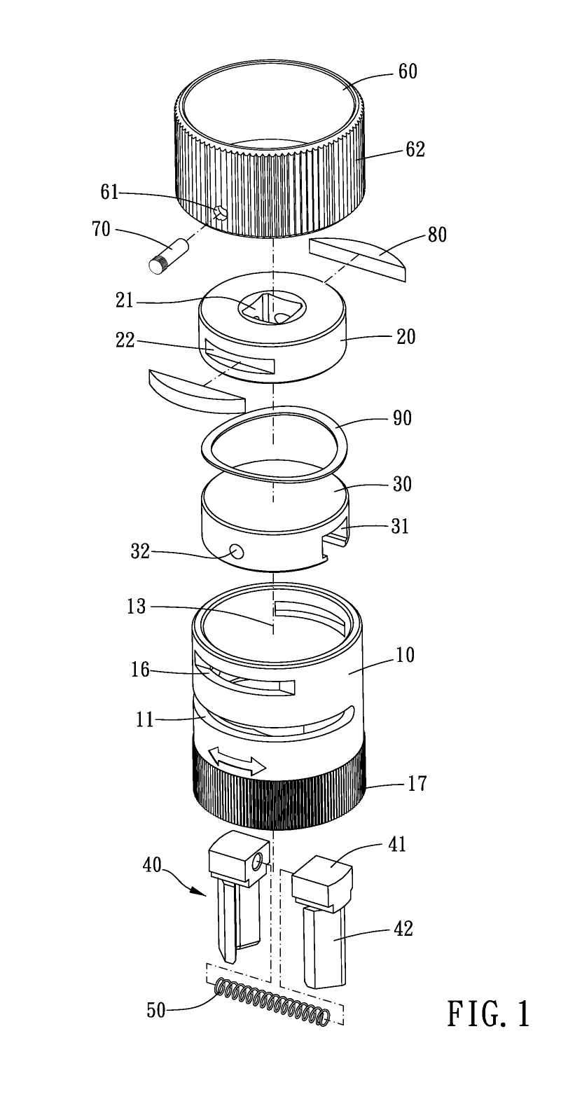

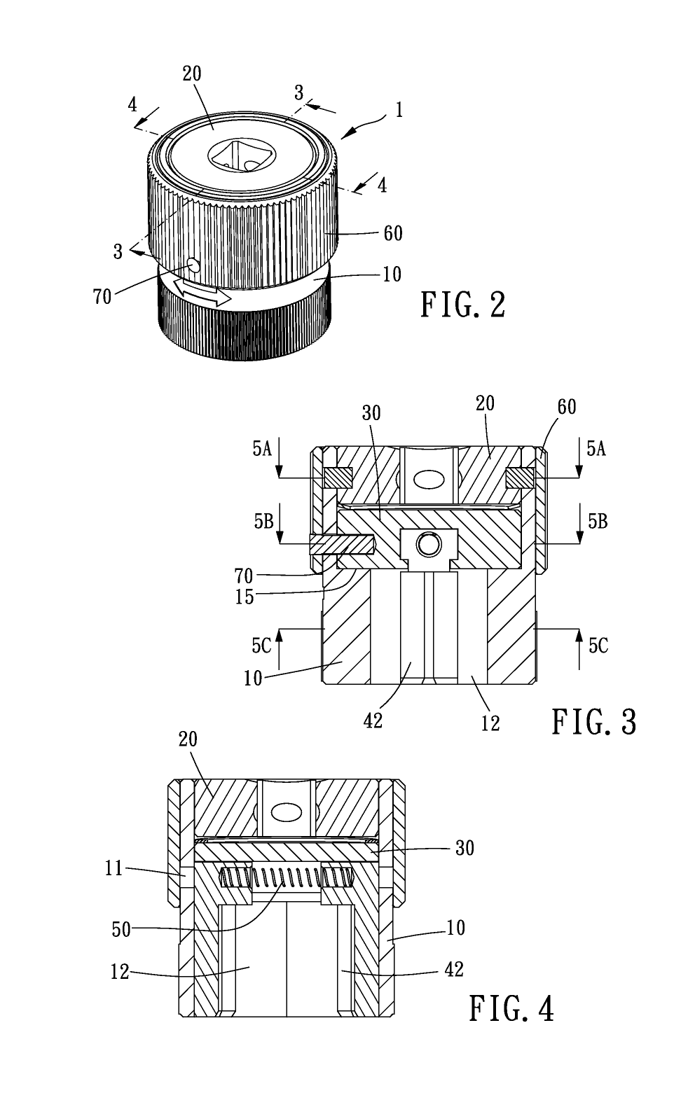

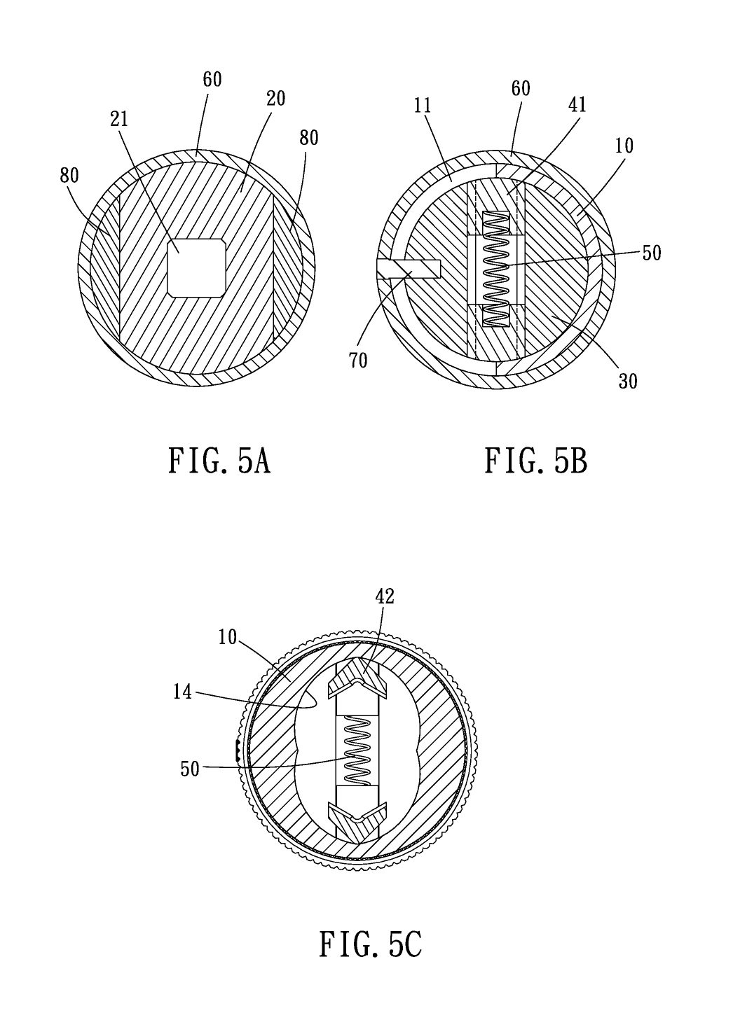

Referring to FIGS. 1-4 and 5A-5C, an adjustable socket 1 includes a main tubular body 10, a drive member 20, a guiding member 30, two jaw members 40, a first elastic member 50, a sleeve ring 60 and a pin 70.

The main tubular body 10 has an elongated through slot 11 circumferentially formed thereon and an urging hole 12 at one end thereof. The main tubular body 10 has a central axis 13, and relative to the central axis 13 the inner wall of the urging hole 12 forms a cam surface 14. Specifically, the cam surface 14 is formed with two c-shaped cambers connected with each other and has an outer contour of “8”. Nevertheless, the structure of the cam surface 14 is able to be changed to match a different demand. The main tubular body 10 is formed with a stepped portion 15 on an inner circular wall thereof. And the main tubular body 10 is formed with at least one positioning through hole 16, specifically, the main tubular body 10 is formed with two the positioning through holes 16. Preferably, at one end of the main tubular body 10 is formed with a slipproof structure 17 on the outer surface, and it is favorable for gripping and operating, However, the slipproof structure 17 may be canceled.

The drive member 20 has a drive portion 21 and is positionably assembled in the other end of the main tubular body 10, specifically, the drive portion 21 is a rectangular cavity which is able to be connected with a driving head of a wrench. However, the drive portion 21 may be formed in other shapes, such as a hexagonal cavity. The drive portion 21 also may be formed with a protruding head which is able to be connected with such as an open wrench or a ring spanner. The drive member 20 is formed with at least one positioning trough 22 corresponding to the at least one positioning through hole 16. In the present embodiment, the drive member 20 is formed with two the positioning troughs 22. Wherein, at least one positioning member 80 inserts in the positioning through hole 16 and the positioning trough 22. In the present embodiment, the positioning member 80 is a half moon, and the shape of the positioning through hole 16 matches the shape of the positioning member 80. The two positioning members 80 respectively insert in the positioning holes 16 and the positioning troughs 22.

The guiding member 30 is assembled within the main tubular body 10 and abuts against the stepped portion 15 (which helps the installation of the guiding member 30). Relative to the main tubular body 10 the guiding member 30 has a guiding slot 31 formed radially, and extending from the bordering of the guiding member 31 inwardly is formed with two guiding fronts and it becomes a narrow entrance. And the guiding member 30 is formed with a first assembling hole 32.

Each of the jaw members 40 includes a guiding portion 41 slidably disposed in the guiding slot 31 and a jaw 42 connected with the guiding portion 41. The two jaws 42 extend into the urging hole 12 and are opposite to each other. Specifically, each guiding portion 41 is T-shaped and it matches the shape of the guiding slot 31. Each of the jaw members 40 is an elongated angular member, and the angular ports of the two angular members are opposite to each other. So that it is favorable for clamping the parts (such as bolts or nuts) stably.

The first elastic member 50 is disposed between the two guiding portions 41. The first elastic member 50 forces the two guiding portions 41 to tend to normally separate away from each other, and the jaw 42 touches the cam surface 14 at all times. The first elastic member 50 may be a helical spring; however, it may be other types.

The sleeve ring 60 is rotatably disposed around the main tubular body 10, and the sleeve ring 60 is formed with a second assembling hole 61. The sleeve ring 60 is disposed around the positioning member 80. Preferably, the sleeve ring 60 is formed with a slipproof structure 62 on an outer surface thereof, so that it is favorable for gripping and operating and makes it easy to rotate the sleeve ring 60 relatively to the main tubular body 10. However, the slipproof structure 62 may be canceled. It is noted that if at least one of the main tubular body 10 and the sleeve ring 60 is formed with a slipproof structure 17, 62, and then it is favorable for gripping and operating.

The pin 70 is disposed through the elongated through slot 11 and two ends thereof are positionably connected respectively to the sleeve ring 60 and the guiding member 30. The two ends of the pin 70 are respectively positionably disposed in the first assembling hole 32 and the second assembling hole 61. When the sleeve ring 60 and the main tubular body 10 rotate relative to each other, the pin 70 circumferentially moves along the elongated through slot 11, wherein, the relative rotating distance between the sleeve ring 60 and the main tubular body 10 is limited by the length of the elongated through slot 11. Preferably, a second elastic member 90 is disposed between the drive member 20 and the guiding member 30, and the second elastic member 90 is a circular or dish-shaped spring. The second elastic member 90 abuts against the drive member 20 and the guiding member 30 along the central axis 13. However, the second elastic member 90 may be canceled and the performance of the adjustable socket 1 is not influenced.

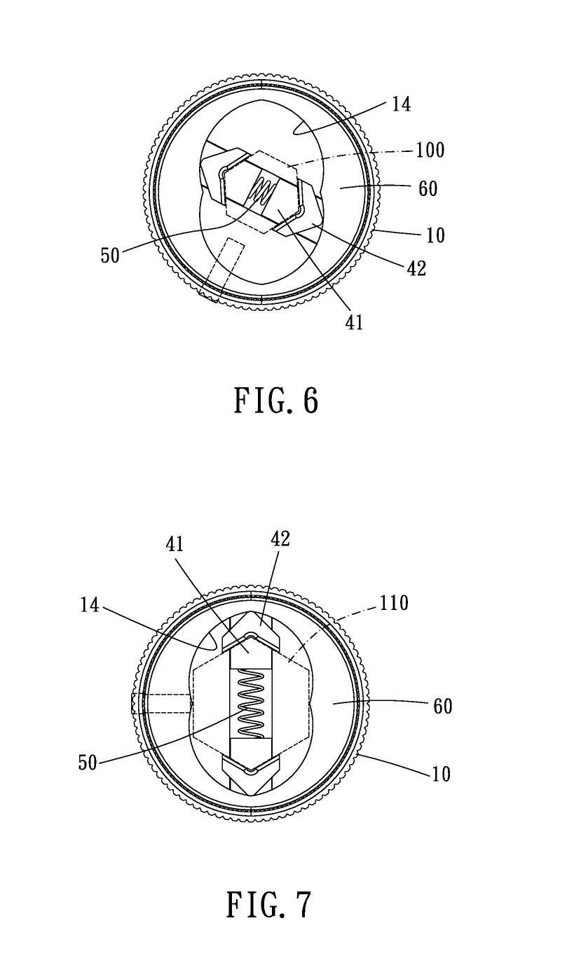

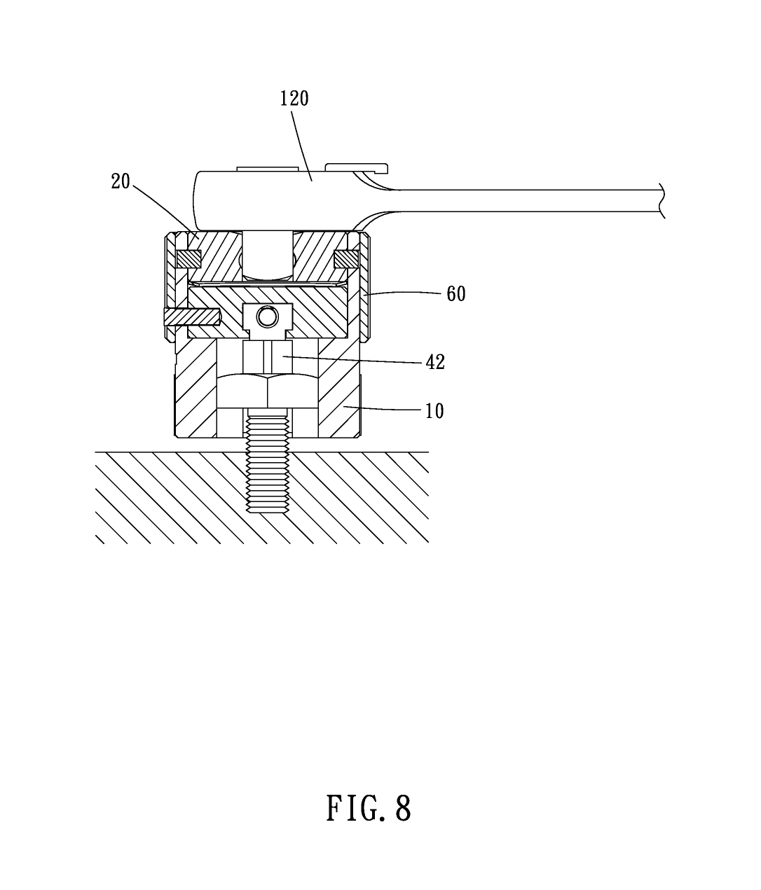

Please refer to a FIG. 6 where a preferable embodiment of the present invention is taken as an example. When gripping the slipproof structure 17 on the main tubular body 10 and the slipproof structure 62 on the sleeve ring 60, for example by two hands, and rotating the sleeve ring 60 relatively to the main tubular body 10, the two jaws 42 are pressed by the cam surface 14 to move along the cam surface 14 and radially move oppositely relative to the central axis 13 inwardly to shorten the distance between the two jaws 42, so that the adjustable socket 1 is suitable for a part with a small dimension, for example a bolt 100. Please refer to a FIG. 7, when the sleeve ring 60 and the main tubular body 10 rotate reversely relative to each other, the two jaws 42 move to a position where the dimension of the urging hole 12 is relatively big in diameter. Meanwhile, the two guiding portions 41 are pressed by the first elastic member 50 so that the two jaws 42 move along the cam surface 14 and radially move away from each other, and therefore the distance between the two jaws 42 is increased. So that the adjustable socket 1 is suitable for a part with a big dimension, for example a bolt 110. Please refer to a FIG. 8, after rotating the sleeve ring 60 relatively to the main tubular body 10 and the distance between the two jaws 42 matches the dimension of the bolt, the two jaws 42 are disposed on the head of the bolt. And the drive member 20 is connected with such as a ratcheting wrench 120 to tighten or release the bolt.

As a conclusion, this invention of adjustable socket only needs a one simple procedure “rotating the sleeve ring and the main tubular body relative to each other”, and the adjustable socket is adjusted to a suitable dimension quickly for applying to bolts or nuts with a variety of dimensions. It is really easy, fast and convenient.

Besides, this invention needs no inner tooth and outer tooth on the sleeve ring and the main tubular body. The structure is simple, and the processing is easy and cost is low. It is favorable for manufacturing and mass production.

While we have shown and described various embodiments in accordance with the present invention, it should be clear to those skilled in the art that further embodiments may be made without departing from the scope of the present invention.

What is claimed is:

1. An adjustable socket, comprising:
a main tubular body, having an elongated through slot circumferentially formed thereon and an urging hole at one end thereof, having a central axis, and relative to the central axis the inner wall of the urging hole formed with a cam surface;
a drive member, having a drive portion and positionably assembled within the other end of the main tubular body;
a guiding member, assembled within the main tubular body and relative to the main tubular body having a guiding slot formed radially;
two jaw members, each jaw member including a guiding portion slidably disposed in the guiding slot and a jaw connected with the guiding portion, the two jaws extending into the urging hole and being opposite to each other;
a first elastic member, abutting between the two guiding portions;
a sleeve ring, rotatably disposed around the main tubular body;
a pin, disposed through the elongated through slot and two ends thereof being positionably connected respectively to the sleeve ring and the guiding member;
wherein when the sleeve ring and the main tubular body rotate relative to each other, the two jaws move along the cam surface and radially move oppositely relative to the central axis.

2. The adjustable socket as claimed in claim 1, wherein the main tubular body is formed with a stepped portion on an inner circular wall thereof, and the guiding member abuts against the stepped portion.

3. The adjustable socket as claimed in claim 1, wherein the cam surface is formed with two c-shaped cambers connected with each other.

4. The adjustable socket as claimed in claim 1, wherein the main tubular body is formed with at least one positioning through hole, the drive member is formed with at least one positioning trough corresponding to the at least one positioning through hole, at least one positioning member inserts in the positioning through hole and the positioning trough, and the sleeve ring is disposed around and abuts against the positioning member.

5. The adjustable socket as claimed in claim 4, wherein the main tubular body is formed with two the positioning through holes corresponding to each other, the drive member is formed with two the positioning troughs corresponding to each other, and the two positioning members respectively insert in corresponding positioning through hole and positioning trough.

6. The adjustable socket as claimed in claim 4, wherein the positioning member is a half moon stud, and the shape of the positioning through hole matches the shape of the positioning member.

7. The adjustable socket as claimed in claim 5, wherein the positioning member is a half moon stud, and the shape of the positioning through hole matches the shape of the positioning member.

8. The adjustable socket as claimed in claim 1, wherein a second elastic member is disposed between the drive member and the guiding member, and the second elastic member abuts against the drive member and the guiding member along the central axis.

9. The adjustable socket as claimed in claim 8, wherein the second elastic member is a circular or dish-shaped spring.

10. The adjustable socket as claimed in claim 1, wherein at least one of the main tubular body and the sleeve ring is formed with a slipproof structure on an outer surface thereof.

11. The adjustable socket as claimed in claim 1, wherein the guiding member is formed with a first assembling hole, the sleeve ring is formed with a second assembling hole, and two ends of the pin are positionably disposed in the first assembling hole and the second assembling hole respectively.
